(19) United States
(12) Patent Application Publication
(10) Pub. No.: US 2016/0197794 A1
(43) Pub. Date: Jul. 7, 2016

(54) QUALITY OF SERVICE SETTING

(71) Applicant: EMC Corporation, Hopkinton, MA (US)

(72) Inventors: Grissom Tianqing Wang, Shanghai (CN); Layne Lin Peng, Shanghai (CN); Vivian Yun Zhang, Shanghai (CN); Roby Qiyan Chen, Shanghai (CN); Kay Kai Yan, Shanghai (CN)

(21) Appl. No.: 14/971,006

(22) Filed: Dec. 16, 2015

(30) Foreign Application Priority Data
Jan. 4, 2015 (CN) 201510004571.7

(51) Int. Cl. H04L 12/24; H04L 12/751

(52) U.S. Cl. CPC H04L 41/5009; H04L 45/02; H04L 41/5038

(57) ABSTRACT

Embodiments of the disclosure relate to a method and apparatus for improving quality of service setting. According to an embodiment of the disclosure, the method comprises: obtaining an abstract QoS from a converged QoS profile, wherein the converged QoS profile indicates a mapping relationship between a converged QoS and the abstract QoS; mapping the abstract QoS to a vendor specific QoS; and implementing QoS setting on the obtained component related to the given application, based on the mapped vendor specific QoS. By introducing a centralized and converged QoS controller, the method simplifies QoS setting and improves the efficiency of QoS setting along the virtual application stack.

### RELATED APPLICATIONS

This application claims priority from Chinese Patent Application Number CN201510004571.7 filed on Jan. 4, 2015 entitled “METHOD AND APPARATUS FOR IMPROVING SETTING OF QUALITY OF SERVICE” the content and teachings of which is herein incorporated by reference in its entirety.

### FIELD OF THE INVENTION

Embodiments of the present disclosure relates to the field of computer network, and more particularly to a method and apparatus to improve QoS setting in a data center and a computer program product.

### BACKGROUND OF THE INVENTION

Computer systems are constantly improving in terms of speed, reliability, and processing capability. As is known in the art, computer systems which process and store large amounts of data typically include a one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems (MSS) typically include an array of a plurality of disks with on-board intelligent and communications electronics and software for making the data on the disks available.

Companies that sell data storage systems and the like are very concerned with providing customers with an efficient data storage solution that minimizes cost while meeting customer data storage needs. It would be beneficial for such companies to have a way for reducing the complexity of implementing data storage.

### SUMMARY OF THE INVENTION

In order to solve some of the above mentioned problems, each exemplary embodiment of the disclosure provides a solution capable of setting the QoS more efficiently.

A first aspect of the disclosure provides a method of setting the quality of service (QoS), comprising obtaining a component related to a given application; obtaining an abstract QoS from a converged QoS profile, wherein the converged QoS profile indicates a mapping relationship between a converged QoS and the abstract QoS; mapping the abstract QoS to a vendor specific QoS; and performing a QoS setting on the obtained component related to a given application based on the mapped vendor specific QoS.

In one embodiment of the disclosure, the component includes at least one of a compute related component, a storage related component and a network related component; the abstract QoS includes at least one of an abstract compute QoS, an abstract storage QoS and an abstract network QoS; and the vendor specific QoS includes at least one of a vendor specific compute QoS, a vendor specific storage QoS and a vendor specific network QoS.

In another embodiment, obtaining a component related to a given application includes obtaining the component by interacting with a management module of each layer in a layered architecture of a data center.

In one embodiment of the disclosure, the method further comprises obtaining component information related to an application instance by interacting with a management module of each layer in a layered architecture of a data center and storing the obtained component information related to the application instance into a topology repository, and wherein obtaining the component related to a given application includes obtaining the component by querying the topology repository.

In one embodiment of the disclosure, wherein obtaining component information related to an application by interacting with a management module of each layer in a layered architecture of a data center includes obtaining the component information related to an application via interacting with at least one of the following: a management module for Software-as-a-service (SaaS), a management module for Platform-as-a-service (PaaS) and a management module for Infrastructure-as-a-service (IaaS) as well as a management module for Infrastructure.

According to another embodiment of the disclosure, wherein mapping the abstract QoS to a vendor specific QoS comprises mapping the abstract QoS to the vendor specific QoS by loading a corresponding QoS driver.

In some embodiments of the disclosure, the method further comprises at least one of the followings: defining the converged QoS profile, storing the converged QoS profile and define a key performance indicator KPI for the at least one of an abstract compute QoS, an storage QoS and a network QoS.

A second aspect of the disclosure provides an apparatus for setting quality of service QoS, comprising: a component determining means, configured to obtain a component related to a given application instance; a QoS abstract means, configured to obtain an abstract QoS from a converged QoS profile, wherein the converged QoS profile indicates a mapping relationship between a converged QoS and the abstract QoS; a QoS mapping means configured to map the abstract QoS to a vendor specific QoS; and a QoS setting means, configured to implement QoS setting on the obtained component related to a given application based on the mapped vendor specific QoS.

According to one embodiment of the disclosure, the component comprises at least one of a compute related component, a storage related component and a network related component; the abstract QoS comprises at least one of an abstract compute QoS, an abstract storage QoS and an abstract network QoS; and the vendor specific QoS comprises at least one of a vendor specific compute QoS, a vendor specific storage QoS and a vendor specific network QoS.

In one embodiment, the component determining means is configured to obtain the component by interacting with a management module of each layer in a layered architecture of a data center.

In another embodiment, the device further comprises a topology discoverer, configured to obtain component information related to an application by interacting with a management module of each layer in a layered architecture of a data center; and a topology repository, configured to store the obtained component information related to the application and wherein the component determining means is configured to obtain the component by querying the topology repository.

In a further embodiment, the topoloty discoverer is configured to obtain the component information related to an application via interacting with at least one of the followings: a management module for Software-as-a-service SaaS, a management module for Platform-as-a-service PaaS, a management module for Infrastructure-as-a-service IaaS and a management module for Infrastructure.

According to some embodiments of the disclosure, the QoS mapping means is configured to map the abstract QoS to a vendor specific QoS by loading a corresponding QoS driver.

In other embodiments of the disclosure, the apparatus further comprises at least one of the following: a converged QoS profile defining means, configured to define the converged QoS profile; a profile storage means, configured to store the converged QoS profile; and an abstract QoS defining means, configured to define a key performance indicator KPI of the at least one of an abstract compute QoS, an abstract storage QoS and an abstract network QoS.

A third aspect of the disclosure provides an apparatus for setting quality of service QoS, comprising: at least one processor; and at least one memory including computer program codes, wherein the at least one memory and the computer program code are configured to, with the at least one processor, cause the apparatus to perform any method according to the first aspect of the disclosure.

A fourth aspect of the disclosure provides a computer program product, which is embodied in a computer-readable medium and comprises computer-readable program instructions; the program-readable instructions, when being loaded into the apparatus, perform any method according to the first aspect of the disclosure.

According to embodiments of the disclosure, QoS setting is simplified by introducing a centralized and converged QoS controller, and the efficiency of QoS setting along the virtual application stack is improved.

### BRIEF DESCRIPTION OF THE DRAWINGS

Now some embodiments of the method and/or apparatus according to the embodiments of the disclosure will be described by way of example, with reference to the drawings, in which:

FIG. 1 illustrates an example of a layered architecture of a data center;

FIG. 2 shows an example of virtual application stack;

FIG. 3 schematically shows an example of a network environment where embodiments of the disclosure can be applied;

FIG. 4 schematically shows a flowchart of an exemplary method according to an embodiment of the disclosure;

FIG. 5 shows an example of adapting to a vendor specific QoS by loading a QoS driver;

FIG. 6 shows a structure diagram of an exemplary apparatus according to an embodiment of the disclosure;

FIG. 7a schematically shows an implementation of an apparatus according to an embodiment of the disclosure;

FIG. 7b schematically shows an interaction between a management module of a layered architecture and a topology discoverer in an apparatus according to an embodiment of the disclosure; and

FIG. 7c schematically shows the implementation of QoS setting on each component by a QoS controller according to an embodiment of the disclosure.

### DETAILED DESCRIPTION

Various exemplary embodiments of the disclosure will be described in details below with reference to the drawings.

It should be understood that these exemplary embodiments are provided only for those skilled in the art to better understand and thus implement the disclosure, rather than for limiting the scope of the disclosure in any manner.

References in the specification to “one embodiment”, “an embodiment”, “a preferred embodiment” etc., indicate that the embodiment described may include a particular feature, structure, or characteristic, but every embodiment may not necessarily include the particular feature, structure, or characteristic. Moreover, such phrases are not necessarily referring to the same embodiment.

It should also be understood that various terminology used herein is for the purpose of describing particular embodiments only and is not intended to be liming of example embodiments. As used herein, the singular forms “a”, “an” and “the” may include the plural forms, unless the context clearly indicates otherwise. It will be further understood that the terms “comprises”, “has” and “including” used herein, specify the presence of stated features, elements, and/or components etc., but do not preclude the presence of one or more other features, elements, components and/or combinations thereof. For example, the term “multiple” used here indicates “two or more”; the term “and/or” used here may comprise any or all combinations of one or more of the items listed in parallel. Definitions of other terms will be specifically provided in the following description.

Furthermore, in the following description, some functions or structures well-known to those skilled in the art will be omitted in order not to obscure embodiments of the disclosure in the unnecessary details.

Embodiments of the disclosure relate to an improvement to QoS setting to simplify setting and improve the efficiency of QoS setting.

For explanatory purpose, some of the following embodiments will describe the main principle of the disclosure with reference to the 3^{rd} platform of a data center. However, as understood by those skilled in the art, the disclosure is not limited to the examples disclosed herein, but can also be applied more widely. For example, the method and apparatus of the disclosure can be applied into QoS setting of any data center as long as it is compatible with the characteristics presented herein.

In many embodiments, in order to simplify QoS setting process for a certain application, avoid unnecessary manual operation and improve the efficiency of QoS setting along the virtual application stack, the current disclosure may provide a centralized and converged QoS controlling method and apparatus. In various embodiments, comparing to software defined data center (SDDC), 3^{rd} platform of a data center may have more focus on support for massive tenants and applications, such as providing support for billions of users and millions of applications potentially.

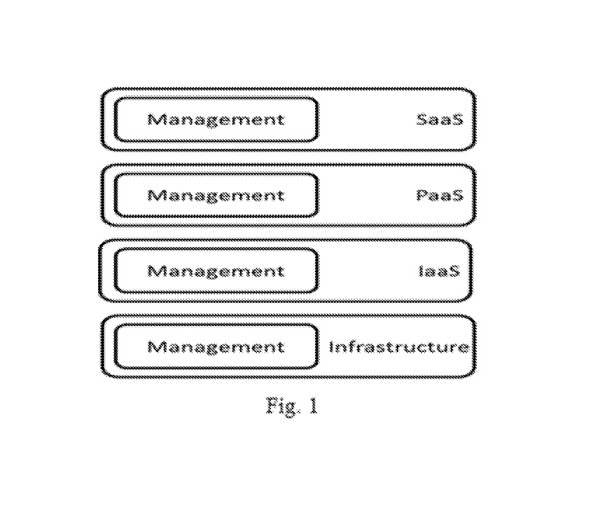

In most embodiments, the 3^{rd} platform may be separated into Software-as-a-service (SaaS), Platform-as-a service (PaaS) and Infrastructure-as-a-service (IaaS) infrastructures. Typically, a typical data center could be illustrated by a layered architecture comprising SaaS/PaaS/IaaS/Infrastructure layers, as shown in FIG. 1. Generally, in each layer, there will be a management module. Conventionally, this management module is an abstraction of different implementations and this module has the information about distribution of its components

Typically, as a plurality of layers are involved, the 3^{rd} platform is a complex structure including virtual and physical components. In such structure, the quality of service (QoS) of a tenant's application is mainly determined by QoS of underlying compute, network and storage. However, generally, it is not convenient for a user to directly configure the underlying QoSs separately, because different compute, network and storage vendors will provide different kinds of implementation of QoS.

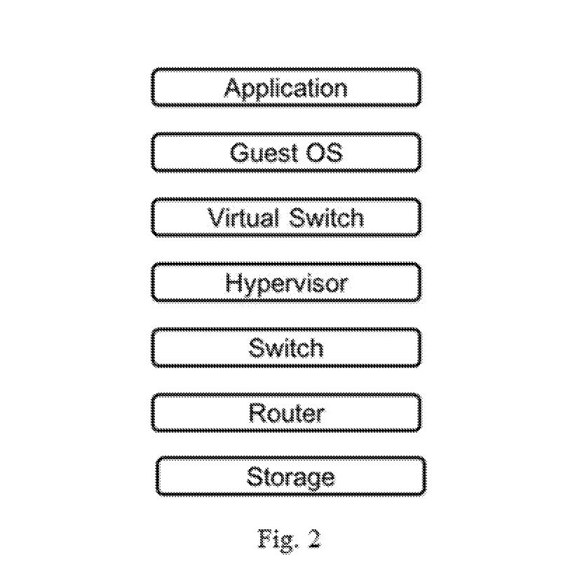

Furthermore, conventionally, from a vertical perspective, for example, a particular application running inside PaaS will typically involve PaaS components, virtual machine (VM), Host, network and storage and so on etc. Typically, this stack is called as a virtual application stack, which refers to physical and virtual resources used by an application from compute to storage. FIG. 2 illustrates another example of virtual application stack. The virtual application stack includes a router, a virtual switch and a hypervisor etc. In such case, in order to finely control QoS of an application, each part involved in the virtual application stack should be controlled.

In summary, if an operator wants to set one application's service level agreement (SLA), compute/network/storage administrators will be involved and they need to set the QoS along the virtual application stack. A lot of virtual assets and physical assets will be involved.

Therefore, at least the following challenges exist now in the QoS setting:

1) the Application Program Interface (API)/Command Line Interface (CLI) vary for different vendors for each type of component;

2) a lot of manual work is involved;

3) it's hard to locate the “path”, i.e., topology information, of related components of a certain application instance along the virtual stack.

Based on the above problems, embodiments of the disclosure provide a method and apparatus to improve QoS setting.

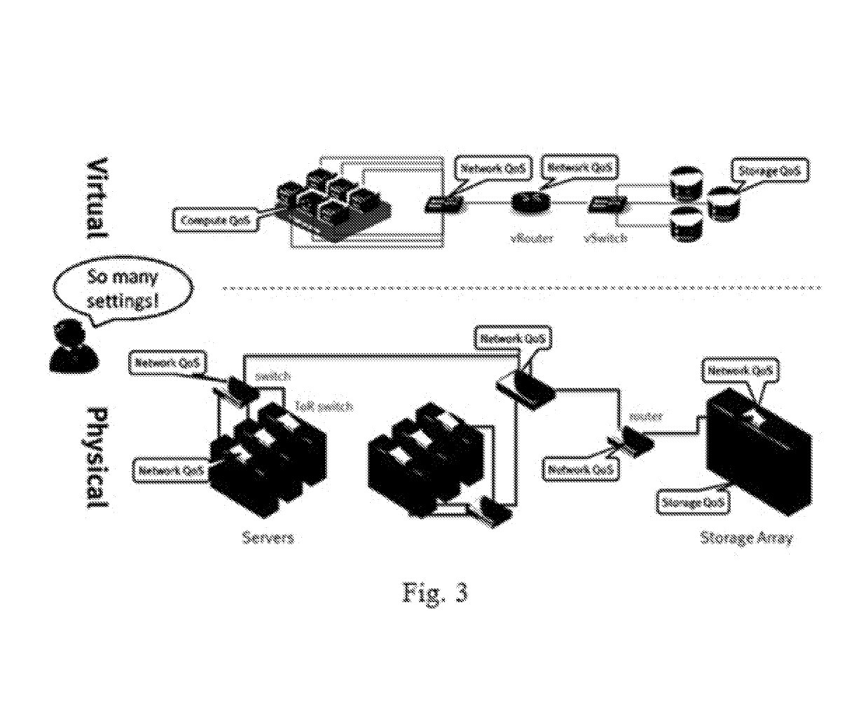

FIG. 3 schematically shows an exemplary network environment where embodiments of the disclosure can be applied. As shown in FIG. 3, an application involves virtual and physical resources and involves a plurality of components. It means that QoS setting of the application relates to QoS setting of the plurality of components, for example, network QoS of a virtual router, storage QoS of a virtual switch and network QoS of a ToR switch may need to be set. Besides, each component can be provided by a different vendor and consequently may result in different Application Program Interface (API)/Command Line Interface (CLI) and different QoS implementations. In this case, QoS setting of an application becomes extremely complicated.

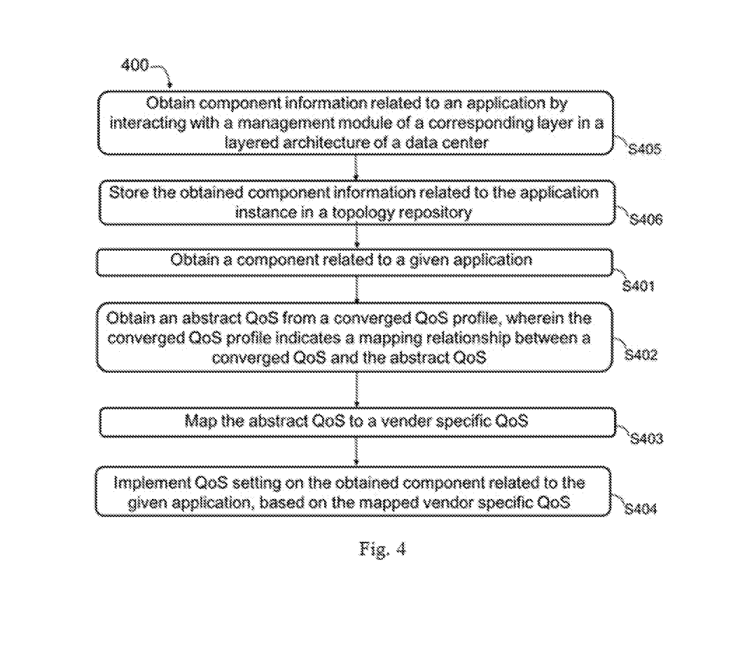

In order to simplify QoS setting, embodiments of the disclosure provide a method and apparatus to improve QoS setting. Firstly, an exemplary method will be described with reference to FIG. 4. As an example, the method may be implemented by a QoS controller in a data center of the network illustrated in FIG. 3. However, embodiments of the disclosure are not limited to this but can be applied more widely. For example, the method may be implemented by an apparatus located outside a data center.

As illustrated in FIG. 4, the method 400 comprises a step S401, in which a QoS controller obtains a component related to a given application instance; in step S402, the QoS controller obtains an abstract QoS from a converged QoS profile, wherein the converged QoS profile indicates a mapping relationship between a converged QoS and the abstract QoS; in step S403, the QoS controller maps the abstract QoS to a vender specific QoS; in step S404, the QoS controller implements QoS setting on the obtained component related to a given application instance based on the mapped vendor specific QoS. The method 400 provides a centralized and automatic QoS setting, which is capable of significantly improving the efficiency of QoS setting. In one embodiment, the component comprises at least one of a compute related component, a storage related component and a network related component; the abstract QoS comprises at least one of an abstract compute QoS, an abstract storage QoS and an abstract network QoS; and the vendor specific QoS comprises at least one of a vendor specific compute QoS, a vendor specific storage QoS and a vendor specific network QoS. In one embodiment, if the given application only involves or mainly involves network aspect, in step S401, the QoS controller can only obtain the network related component rather than all the components related to compute, storage and network. Similarly, in another embodiment, in step S401, the QoS controller may only obtain the compute or storage related component or obtain all the components related to compute, storage and network depending on the nature of an application.

In another embodiment, in step S401, the QoS controller can obtain a component related to a given application instance by interacting with a management module of a corresponding layer in a layered architecture of a data center. For example, assuming the layered architecture is as illustrated in FIG. 1, in step S401, the QoS controller can interoperate with the management module of one or a plurality of layers in SaaS/PaaS/IaaS/Infrastructure layers to obtain the component information. The management modules can exist currently and can already have the topology information of the component stored. The QoS controller can also calculate the cross-layer topology information based on name convention or unified ID across the stack. It should be noted that the layered architecture in FIG. 1 is only presented for exemplary purpose, and a data center can adopt any suitable layered architecture, for example, it may have more or different layers, in other embodiments.

In another embodiment, the step 400 may further comprise a selectable step S405, in which the QoS controller obtains component information related to an application instance by interacting with a management module of a corresponding layer in a layered architecture of a data center; and in a selectable step S406, stores the obtained component information related to the application instance in a topology repository; in the embodiment, in step S401, the QoS controller may obtain the component related to the given application instance via querying the topology repository. The advantage of the embodiment is that it avoids interacting with a management module of a virtual stack for every application. Instead, it pre-stores topology information for query, which further lowers the complexity of calculation and reduces the processing time.

In one embodiment, in step S402, the QoS controller obtains an abstract QoS from a converged QoS profile. The converged QoS profile indicates a mapping relationship between a converged QoS and the abstract QoS, for example, the converged QoS profile maps a high level converged QoS to an abstract storage QoS, a network QoS and a compute QoS. As an example, the converged QoS profile can indicate: converged_gold_QoS, [storage_gold_QoS, network_gold_QoS, compute_gold_QoS] and as for storage_gold_QoS, some detailed key performance indicators (KPI), like input and output per second (IOPS) or response time will be defined, for example, storage_gold_QoS=[IOPS>100K, response time<5 ms]. It can be appreciated by those skilled in the art that the above mapping relationship is only provided as an example and any suitable mapping relationship may be defined depending on needs and/or requirement of vendors or users.

According to embodiments of the disclosure, an abstract QoS is an abstraction of underlying QoS (such as compute QoS, storage QoS and network QoS etc.). Take storage QoS for instance, although different vendors may have different implementations and definitions regarding storage QoS, for example, regarding the VNX for storage, its QoS can comprise I/O class, policy and schedule. However, in one embodiment of the disclosure, a unified and abstract storage QoS can be defined, for example, throughput and response time are used as the two fundamental key performance indicators (KPIs). It can be appreciated that similar processing can be performed for other underlying QoS (such as compute QoS and network QoS). For example, a vendor specific QoS can comprise one or more of a vendor specific compute QoS, a vendor specific storage QoS and a vendor specific network QoS, and for these underlying QoS, such as (but not limited to) compute QoS, storage QoS and network QoS, an abstract QoS can be defined respectively in order to simplify the process. It should be noted that an abstract QoS can be defined specifically based on experience and need, and the above examples are provided only for the purpose of explanation rather than limitation. Then, a converged QoS is to be defined as a combination of one or more abstract QoS, for example, it can be defined as a combination of storage QoS, network QoS and compute QoS. According to an embodiment of the disclosure, the relationship between the converged QoS and the abstract QoS is defined in a converged QoS profile. Thus, in some embodiments of the disclosure, the method 400 may further comprise one or more of the following selectable steps (not shown in FIG. 4):

Define the converged QoS profile;

Store the converged QoS profile; and

Define a key performance indicator KPI of the at least one of an abstract compute QoS, an abstract storage QoS and an abstract network QoS.

In another embodiment, one or more of the above steps can be implemented by other apparatus outside of the QoS controller. In this case, the method 400 can use the result of definition and storage through interacting with other components rather than directly implementing these steps.

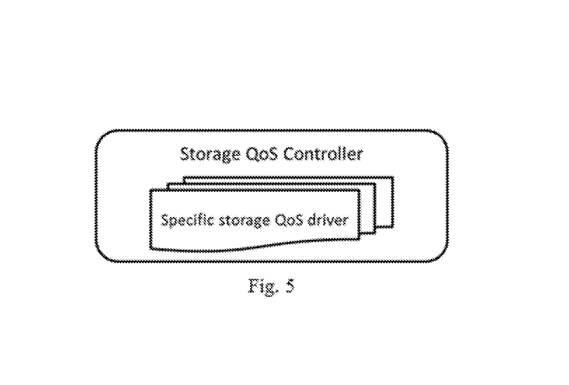

In one embodiment of the disclosure, in step S403, the QoS controller can map the abstract QoS to a vendor specific QoS by loading a corresponding QoS driver. In other words, use an adaptor mechanism to adapt to different products offered by different vendors. For example, if VNX product is used as backend storage, then a VNX storage QoS driver will be introduced, such as installed in a storage QoS controller. Thus, when setting storage QoS, in step S403, a VNX storage QoS driver will be used to map an abstract storage QoS to a vendor specific storage QoS, and in step S404, a QoS setting operation will be perform on a given VNX which is obtained in step S401. FIG. 5 shows an example of loading a specific storage QoS driver into a storage QoS controller, which is a part of the QoS controller capable of implementing method 400. Similar design can be applied to a network QoS controller and a storage QoS controller.

A method to improve QoS setting according to an embodiment of the disclosure is described above with reference to drawings. The method can automatically perform QoS setting in a centralized manner to avoid unnecessary manual work, self-adapt to a vendor specific QoS of each component and improve the efficiency of QoS setting.

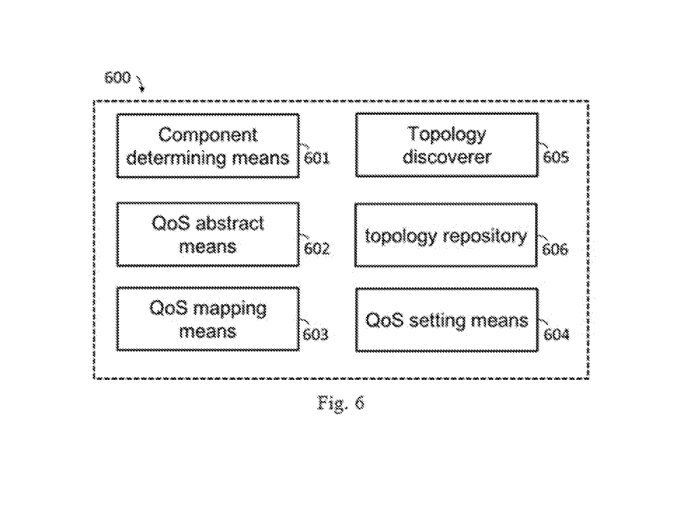

An apparatus 600 to improve QoS setting according to an embodiment of the disclosure is described below with reference to FIG. 6. FIG. 6 schematically illustrates the structure of apparatus 600. The apparatus 600 may be a QoS controller, configured to implement any method described with reference to FIG. 4, but it is not limited to implement the method described above. Similarly, the above described method can be implemented by the apparatus 600, but it is not limited to be implemented by the apparatus 600. In one embodiment, at least one step of method 400 can be implemented by one or more other means.

As shown in FIG. 6, the apparatus 600 comprises a component determining means 601, configured to obtain a component related to a given application instance; a QoS abstract means 602, configured to obtain an abstract QoS from a converged QoS profile, wherein the converged QoS profile indicates a mapping relationship between a converged QoS and the abstract QoS; a QoS mapping means 603, configured to map the abstract QoS to a vendor specific QoS; and a QoS setting means 604, configured to implement QoS setting on the component related to the given application instance obtained by the component determining means 601 based on the mapped vendor specific QoS.

According to one embodiment of the disclosure, components of the apparatus 600 can be configured to implement respectively each step of the method 400 described with reference to FIG. 4. Therefore, the description of each step of the method 400 also applies to each component of apparatus 600.

In one embodiment, the components obtained by the component determining means 601 comprise at least one of a compute related component, a storage related component and a network related component; the abstract QoS comprises at least one of an abstract compute QoS, an abstract storage QoS and an abstract network QoS; and the vendor specific QoS comprises at least one of a vendor specific compute QoS, a vendor specific storage QoS and a vendor specific network QoS. In one embodiment, if a certain application only involves or mainly involves network aspect, the component determining means 601 can be configured to only obtain a network related component rather than all the components related to compute, storage and network. Similarly, in another embodiment, the component determining means 601 can be configured to only obtain a compute or storage related component or obtain all the components related to compute, storage and network depending on the nature of an application.

In another embodiment, the component determining means 601 can be configured to obtain a component related to a given application instance by interacting with a management module of each layer in a layered architecture of a data center. For example, assuming the layered structure is as illustrated in FIG. 1, the component determining means 601 can be configured to interoperate with a management module of one or a plurality of layers in the SaaS/PaaS/IaaS/Infrastructure layers to get component information. The management modules may be existing ones and may already have the topology information of the component(s) stored. The component determining means 601 can be configured to calculate cross-layer topology information based on name convention or unified ID across the stack. It should be noted that the layered architecture in FIG. 1 in only provided for exemplary purpose and a data center can adopt any suitable layered architecture, for example, it may have different layers and/or different number of layers, in other embodiments.

In still another embodiment, the apparatus 600 may further comprise a optional topology discoverer 605, configured to interact with a management module of a corresponding layer in a layered architecture of a data center to obtain component information related to an application instance; and a topology repository 606, configured to store the obtained component information related to the application instance; in the embodiment, the component determining means 601 can be configured to obtain the component related to the given application instance via querying the topology repository. The advantage of the embodiment is that it avoids interacting with a management module of a virtual stack regarding each application, and pre-stores topology information for query which further lowers the complexity of calculation and reduces processing time.

In one embodiment, the QoS abstract means 602 obtains an abstract QoS from a converged QoS profile. The converged QoS profile indicates a mapping relationship between the abstract QoS and a converged QoS, which can be defined as a combination of one or more abstract QoS. The abstract QoS is abstraction of underlying QoS (such as compute QoS, storage QoS and network QoS, etc.). Since the converged QoS profile, the abstract QoS and the relationship therebetween have been described in details respectively with reference to FIG. 4 and method 400, they will not be repeated here.

In some embodiments of the disclosure, the apparatus 600 may further comprise one or more of the following means, which are not shown in FIG. 6:

A converged QoS profile definition means, configured to define the converged QoS profile;

A profile storage means, configured to store the converged QoS profile; and

An abstract QoS definition means, configured to define a key performance indicator KPI of the at least one of an abstract compute QoS, an abstract storage QoS and an abstract network QoS.

In another embodiment, the above means can also be implemented outside the apparatus 600, and in such embodiment, the apparatus 600 can utilize the defined and stored results by interacting with these means rather than directly comprising these means.

In one embodiment of the disclosure, the QoS mapping means 603 can be configured to map the abstract QoS to a vendor specific QoS by loading a corresponding QoS driver. In other words, a QoS mapping means 603 can use an adaptor mechanism to adapt to different products offered by different vendors. For example, if VNX product is used as backend storage, then a VNX storage QoS driver will be introduced, for example be installed in the QoS mapping means 603. Thus when setting a storage QoS, the VNX storage QoS driver will be used to map an abstract storage QoS to a vendor specific QoS by the QoS mapping means 603. Besides, the QoS setting means 604 will perform QoS setting operation on a certain VNX, which component is obtained by the component determining 601. FIG. 5 shows an example of loading a specific storage QoS driver to a storage QoS controller, wherein the storage QoS controller can be an example of the QoS mapping means 603. A design similar to that of FIG. 5 can also be applied to loading a network QoS driver and a compute QoS driver.

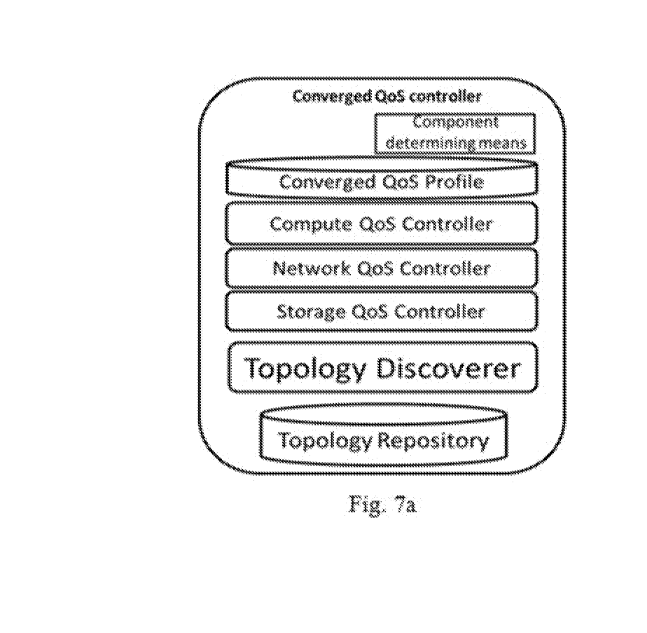

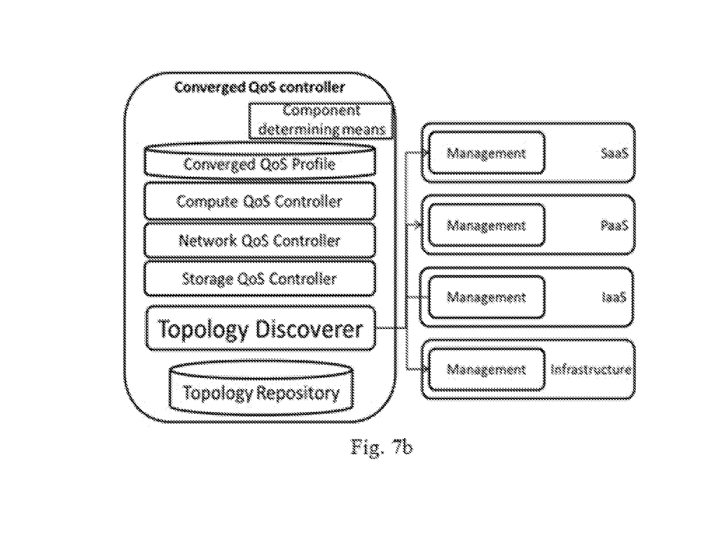

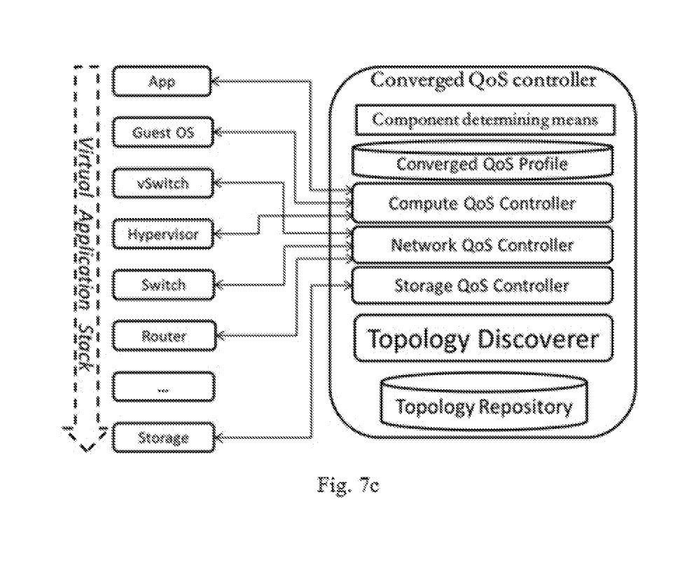

FIG. 7a shows an example of the apparatus 600 according to one embodiment of the disclosure. In the example, a converged QoS controller is an example of the apparatus 600. A topology discoverer in the converged QoS controller can obtain topology information by interacting with a management module in a layered architecture of a data center and the schematic diagram of the interaction is shown in FIG. 7b. Then the obtained information is stored in a topology repository. A component obtaining means in the converged QoS controller obtains a corresponding component of a certain application via querying the topology repository. In an example of FIG. 7a, a converged QoS profile defines a mapping between a converged QoS and an abstract QoS; while a compute QoS controller, a network QoS controller and a storage QoS controller can be operated as the QoS mapping means 603 and the QoS setting means 604 in FIG. 6, i.e., they can be configured to map an abstract QoS to a vendor specific QoS and set a compute QoS, a network QoS and a storage QoS on a corresponding component respectively. FIG. 7c shows a schematic diagram of the compute QoS controller, network QoS controller and storage QoS controller setting QoS on a virtual stack. As shown in FIG. 7c, different QoS controllers perform QoS setting with respect to related components.

As described above, the method 400 and the apparatus 600 according to embodiments of the disclosure provide an automatic mechanism to get the topology information of the virtual application stack and simplify QoS setting for specific applications by introducing a converged QoS. Thus, it could provide an application oriented and fine-grained QoS control in a complex data center.

Although the implementations of the method/device presented in the disclosure are described mainly by taking the layered architecture of a data center as an example, the embodiments of the disclosure are not limited to this but can be widely applied, as can be appreciated by those skilled in the art.

Those skilled in the art should understand that any structural diagram described here represents an explanatory schematic diagram for implementing the principles of the disclosure. Similarly, it should be understood that the flowchart described here may represent various processes that can be specifically embodied in a machine-readable medium and can be implemented by a machine or a processing device, no matter whether such machine or process device is explicitly shown.

Those skilled in the art should also understand that one or more steps in the method steps mentioned in the disclosure can also be implemented in a single functional block or by a single device. However in some embodiments, a functional block can also realize a plurality of method steps or the function of a plurality of functional blocks.

Each unit included in the apparatus 600 according to the embodiments of the disclosure can be implemented in various manners, comprising software, hardware, firmware or any combinations thereof. For example, in some embodiments, the apparatus 600 can be implemented by software and/or firmware. Alternatively or additionally, the apparatus 600 can be implemented partly or totally based on hardware. For example, one or more units in the apparatus 600 can be implemented as integrated circuit (IC) chip, application specific integrated circuit (ASIC), system-on-chip (SOC), and field programmable gate array (FPGA) etc. The scope of the disclosure is not restricted in this regard. Besides, in some embodiments, a single means in the apparatus 600 can also be implemented by a plurality of means; in other embodiments, the function of a plurality of means in the apparatus 600 can also be implemented as a single means.

The disclosure can be a system, an apparatus, a device, a method and/or a computer program product. According to an embodiment of the disclosure, the invention can be implemented by an apparatus for QoS setting, the apparatus comprising at least one processor; and at least one memory including computer program codes, wherein the at least one memory and the computer program codes are configured to, with the at least one processor, cause the apparatus to implement any of the above method described with reference to FIG. 4. According to another embodiment, the invention can be implemented by a computer program product, the computer program product being embodied in a computer-readable medium and comprising computer-readable program instructions; the computer-readable instructions, when being loaded into an apparatus, implement any method according to embodiments of the disclosure.

The above descriptions with reference to the drawings are only presented for exemplary purpose to explain the disclosure. Those skilled in the art can understand that different structures can be proposed based on the principles of the disclosure described above. Although these different structures are not described or shown explicitly, they all embody the principles of the disclosure and are included within the spirit and scope thereof. Furthermore, all examples mentioned herein are expressly for pedagogical purpose to help the reader to understand the principles of the disclosure and the ideas contributed by the inventor to further develop the field. They should not be construed as limitations to the scope of the disclosure. Besides, the descriptions of all the mentioned principles, aspects and embodiments of the disclosure and the specific examples include their equivalents.

1. A method of setting quality of service (QoS), comprising:
obtaining a component related to a given application;
obtaining an abstract QoS from a converged QoS profile, wherein the converged QoS profile indicates a mapping relationship between a converged QoS and the abstract QoS;
mapping the abstract QoS to a vendor specific QoS; and
implementing QoS setting on the obtained component related to the given application, based on the mapped vendor specific QoS.

2. A method according to claim 1, wherein:
the component comprises at least one of a compute related component, a storage related component and a network related component;
the abstract QoS comprises at least one of an abstract compute QoS, an abstract storage QoS and an abstract network QoS; and
the vendor specific QoS comprises at least one of a vendor specific compute QoS, a vendor specific storage QoS and a vendor specific network QoS.

3. The method according to claim 1, wherein obtaining a component related to a given application comprises:
obtaining the component by interacting with a management module of each layer in a layered architecture of a data center.

4. The method according to claim 1, further comprises:
obtaining component information related to an application instance by interacting with a management module of each layer in a layered architecture of a data center, and
storing the obtained component information related to the application instance in a topology repository, and
wherein obtaining a component related to a given application instance includes:
obtaining the component by querying the topology repository.

5. The method according to claim 4, wherein obtaining component information related to an application instance by interacting with a management module of each layer in a layered architecture of a data center comprises:
obtaining the component information related to an application by interacting with at least one of the followings:
a management module for Software-as-a-service (SaaS);
a management module for Platform-as-a-service (PaaS);
a management module for Infrastructure-as-a-service (IaaS); and
a management module for Infrastructure.

6. The method according to claim 1, wherein mapping the abstract QoS to a vendor specific QoS comprises:
mapping the abstract QoS to a vendor specific QoS by loading a corresponding QoS driver.

7. The method according to any of claims 1-6, further comprises at least one of the followings:
defining the converged QoS profile;
storing the converged QoS profile; and
defining a key performance indicator (KPI) for at least one of an abstract compute QoS, an abstract storage QoS and an abstract network QoS.

8. A system, comprising:
a data center, including data storage systems; and
computer-executable program logic encoded in memory of one or more computers enabled to set quality of service (QoS) within the data center, wherein the computer-executable program logic is configured for the execution of:
obtaining a component related to a given application;
obtaining an abstract QoS from a converged QoS profile, wherein the converged QoS profile indicates a mapping relationship between a converged QoS and the abstract QoS;
mapping the abstract QoS to a vendor specific QoS; and
implementing QoS setting on the obtained component related to the given application, based on the mapped vendor specific QoS.

9. The system of claim 8, wherein:
the component comprises at least one of a compute related component, a storage related component and a network related component;
the abstract QoS comprises at least one of an abstract compute QoS, an abstract storage QoS and an abstract network QoS; and
the vendor specific QoS comprises at least one of a vendor specific compute QoS, a vendor specific storage QoS and a vendor specific network QoS.

10. The system of claim 8, wherein obtaining a component related to a given application comprises:
obtaining the component by interacting with a management module of each layer in a layered architecture of a data center.

11. The system of claim 8, wherein the computer-executable program logic is further configured for the execution of:
obtaining component information related to an application instance by interacting with a management module of each layer in a layered architecture of a data center, and
storing the obtained component information related to the application instance in a topology repository, and
wherein obtaining a component related to a given application instance includes:
obtaining the component by querying the topology repository.

12. The system of claim 11, wherein obtaining component information related to an application instance by interacting with a management module of each layer in a layered architecture of a data center comprises:
obtaining the component information related to an application by interacting with at least one of the followings:
a management module for Software-as-a-service (SaaS);
a management module for Platform-as-a-service (PaaS);
a management module for Infrastructure-as-a-service (IaaS); and
a management module for Infrastructure.

13. The system of claim 8, wherein mapping the abstract QoS to a vendor specific QoS comprises:
mapping the abstract QoS to a vendor specific QoS by loading a corresponding QoS driver.

14. The system of claim 8, wherein the computer-executable program logic is further configured for the execution of at least one of the followings:
defining the converged QoS profile;
storing the converged QoS profile; and
defining a key performance indicator (KPI) for at least one of an abstract compute QoS, an abstract storage QoS and an abstract network QoS.

15. A computer program product of setting quality of service (QoS), the computer program product comprising:
a non-transitory computer readable medium encoded with computer-executable code, the code configured to enable the execution of:
obtaining a component related to a given application;
obtaining an abstract QoS from a converged QoS profile, wherein the converged QoS profile indicates a mapping relationship between a converged QoS and the abstract QoS;
mapping the abstract QoS to a vendor specific QoS; and
implementing QoS setting on the obtained component related to the given application, based on the mapped vendor specific QoS.

16. The computer program product of claim 15, wherein:
the component comprises at least one of a compute related component, a storage related component and a network related component;
the abstract QoS comprises at least one of an abstract compute QoS, an abstract storage QoS and an abstract network QoS; and
the vendor specific QoS comprises at least one of a vendor specific compute QoS, a vendor specific storage QoS and a vendor specific network QoS.

17. The computer program product of claim 15, wherein obtaining a component related to a given application comprises:
obtaining the component by interacting with a management module of each layer in a layered architecture of a data center.

18. The computer program product of claim 15, wherein the code is further configured to enable the execution of:
obtaining component information related to an application instance by interacting with a management module of each layer in a layered architecture of a data center, and
storing the obtained component information related to the application instance in a topology repository, and
wherein obtaining a component related to a given application instance includes:
obtaining the component by querying the topology repository.

19. The computer program product of claim 18, wherein obtaining component information related to an application instance by interacting with a management module of each layer in a layered architecture of a data center comprises:
obtaining the component information related to an application by interacting with at least one of the followings:
a management module for Software-as-a-service (SaaS);
a management module for Platform-as-a-service (PaaS);
a management module for Infrastructure-as-a-service (IaaS); and
a management module for Infrastructure.

20. The computer program product of claim 15, wherein mapping the abstract QoS to a vendor specific QoS comprises:
mapping the abstract QoS to a vendor specific QoS by loading a corresponding QoS driver.
